(19) United States
(12) Patent Application Publication
(10) Pub. No.: US 2014/0355942 A1
(43) Pub. Date: Dec. 4, 2014

(54) INDUCTION FREE, FLAME RETARDANT COMPACT DROP CABLE

(71) Applicants: Yoshio Hashimoto, Greer, SC (US); Joe Cignarale, Greer, SC (US)

(72) Inventors: Yoshio Hashimoto, Greer, SC (US); Joe Cignarale, Greer, SC (US)

(73) Assignee: AFL TELECOMMUNICATIONS LLC, Duncan, SC (US)

(21) Appl. No.: 14/125,988

(22) PCT Filed: Jun. 15, 2012
(86) PCT No.: PCT/US2012/042584

§ 371 Date: Jul. 10, 2014

Related U.S. Application Data
(60) Provisional application No. 61/497,375, filed on Jun. 15, 2011.

(51) Int. Cl. G02B 6/44

(52) U.S. Cl. CPC G02B 6/4432
USPC 385/102

(57) ABSTRACT

An optical fiber cable with an optical fiber, an FR-aramid yarn, and a jacket that can be used as a flame retardant compact drop cable for multiple dwelling units.

### BACKGROUND 1. Field

The invention is related to a flame retardant compact drop cable, which can be used in multiple dwelling units, as well as other applications.

2. Related Art

A typical structure of a drop cable 10 for the Asian region is shown in FIG. 1. The structure consists of two strength members 2 and one or more fibers 1 surrounded by a jacket material 3. Two strength members 2 are typically made the steel wires or fiberglass reinforced plastic (FRP), depending on the customer's needs. The jacket material 3, may be made of polyethylene or PVC, also depending on the customer's needs. Because of its small dimensions, many kind of cabling designs are possible. However, one restriction that may limit the use of this cable is the flame retardant (FR) requirements for particular installation areas (for example UL 1666 in Riser, NFPA262 in Plenum area, etc.). Generally, it is difficult to protect a smaller cable from burning.

It is an object of the invention to produce cable structure that is more flame retardant and able to pass stringent flame retardant requirements.

### SUMMARY

Exemplary implementations of the present invention address at least the above problems and/or disadvantages and other disadvantages not described above. Also, the present invention is not required to overcome the disadvantages described above, and an exemplary implementation of the present invention may not overcome any of the problems listed above.

An embodiment of the invention is an optical fiber cable that includes an optical fiber, an FR-aramid yarn, and a jacket.

Other features of the invention include: the FR-aramid yarn being an aramid yarn with a flame retardant coating and the FR-aramid yarn having a flame resistant coating which is formulated to create an expanding char on the yarn surface to suppress both flame and smoke when subjected to high heat.

Other features of the invention include: the FR-aramid yarn having and the cable having a second FR-aramid yarn, wherein the optical fiber is arranged between the yarns. Also, the cable may include a second FR-aramid yarn that includes FRP, wherein the optical fiber is arranged between said yarns.

Other features of the invention include: the jacket material having FR-PE and the jacket material satisfying LSZH requirements, such as IEC 60754-2, 61034-2 and 60332-3 requirements.

Other features of the invention include: the jacket material having an FR-PVC, the jacket material satisfying NFPA262 requirements and the jacket material satisfying UL1666 requirements.

### BRIEF DESCRIPTION OF THE DRAWING

FIG. 1 shows an exemplary embodiment of the optical fiber of the invention.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

Hereinafter, the exemplary embodiments will be described with reference to accompanying drawings.

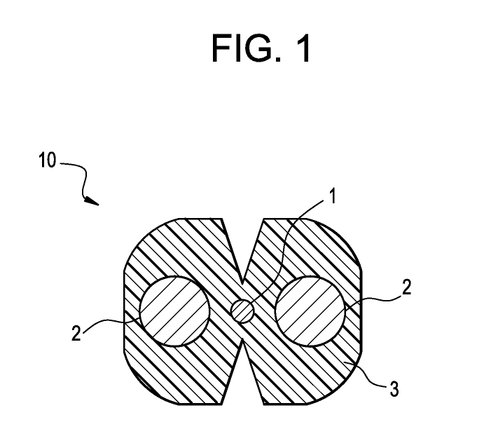

The new concept induction free (or non-metallic), FR optical fiber cable maintains a similar structure as the cable in FIG. 1. However, the types and combinations of materials make the cable unique. In one embodiment, two 0.5 mm diameter FR-aramid FRPs 2 and an optical fiber 1 are tightly surrounded by a jacket material 3.

The 0.5 mm diameter FR-aramid FRP may be comprised of aramid yarn with an FR coating, such as Fiber-Line (FL-K1420/1803). The aramid yarn with an FR coating is a high modulus 1420 denier aramid yarn impregnated with a FR coating. The coating is formulated to create an expanding char on the fiber surface to suppress both flame and smoke when subjected to high heat. The specific properties of this yarn are shown in the table below:

| Property | Test method | Min | Nom | Max |
|---|---|---|---|---|
| Break strength, lbf | ASTM D885 | 60 (27.2) | 65 (29.5) | — |
| (kgf) | | | | |
| Elongation @ break, % | ASTM D885 | — | 2.3 | 2.7 |
| Yield - moisture incl.: | ASTM D1907 | 1830 (2033 | 2030 (2255) | 2270 (2522) |
| Denier (dtex) | | | | |
| Yield - moisture-free: | ASTM D1907 | 1820 (2022) | 1990 (2210) | 2180 (2422) |
| Denier (dtex) | | | | |
| Moisture: % | ASTM D2654 | 0.5 | 2.0 | 4.0 |
| Coating Solids | SOP 10-02-08-TP | 22.0 | 28.0 | 34.0 |

The jacket material may be comprised of Meglon HF8553 from Alpha Gary, DFDA1638NT from Dow, FR4810 from Boreals or other FR-PE materials in order to pass low smoke zero halogen (LSZH) requirements, such as IEC 60754-2, 61034-2 and 60332-3. The LSZH requirements are well known to one skilled in the art.

The jacket may be comprised of Fireguard 910-NL1 from Teknor or other FR-PVC materials in order to pass the NFPA262 requirements. The NFPA262 requirements are well known to one skilled in the art.

The jacket may be comprised of GW 2038A VW1 LCF from AlphaGary or other FR-PVC materials in order to pass the UL1666 requirements. The UL1666 requirements are well known to one skilled in the art.

As mentioned above, although the exemplary embodiments described above are various types of cables, they are merely exemplary and the general inventive concept should not be limited thereto, and it could also apply to other types of optical cables. In particular, while the invention may be used in MDUs, the invention may be used in other types of applications.

What is claimed:

1. An optical fiber cable comprising:
an optical fiber;
an FR-aramid yarn; and
a jacket.

2. The optical fiber cable according to claim 1, wherein the FR-aramid yarn is an aramid yarn with a flame retardant coating.

3. The optical fiber cable according to claim 2, wherein the FR-aramid yarn has a flame resistant coating which is formulated to create an expanding char on the yarn surface to suppress both flame and smoke when subjected to high heat.

4. The optical fiber cable according to claim 1, wherein the FR-aramid yarn comprises FRP.

5. The optical fiber cable according to claim 1, further comprising a second FR-aramid yarn, wherein said optical fiber is arranged between said yarns.

6. The optical fiber cable according to claim 4, further comprising a second FR-aramid yarn that comprises FRP, wherein said optical fiber is arranged between said yarns.

7. The optical fiber cable claimed in claim 1, wherein the jacket material comprises FR-PE.

8. The optical fiber cable claimed in claim 7, wherein the jacket material satisfies LSZH requirements.

9. The optical fiber cable claimed in claim 8, wherein the jacket material satisfies LSZH (IEC 60754-2, 61034-2, 60332-3) requirements.

10. The cable claimed in claim 1, wherein the jacket material comprises an FR-PVC.

11. The optical fiber cable claimed in claim 10, wherein the jacket material satisfies NFPA262 requirements.

12. The optical fiber cable claimed in claim 10, wherein the jacket material satisfies UL1666 requirements.
